(19) United States
(12) Patent Application Publication
(10) Pub. No.: US 2008/0100452 A1
(43) Pub. Date: May 1, 2008

(54) RFID tag with barcode symbology antenna configuration

(75) Inventor: Philip Lazo, Mount Airy, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/590,877

(22) Filed: Nov. 1, 2006

(51) Int. Cl. G08B 13/14

(52) U.S. Cl. 340/572.7; 340/572.8

(57) ABSTRACT

Methods and apparatuses for assembling and implementing optically machine readable radio frequency identification (RFID) tags are described. An RFID tag comprises a substrate, an electrical circuit mounted on the substrate, and an antenna that is configured to be machine readable. For example, the antenna may include a plurality of electrically conductive substantially rectangular bars formed on a first surface of the substrate. Bars of the plurality of electrically conductive substantially rectangular bars are positioned in parallel with each other and are configured to be an optically machine readable symbol. Bars of the plurality of electrically conductive substantially rectangular bars form at least one antenna. The electrical circuit is electrically coupled to the plurality of electrically conductive substantially rectangular bars. Alternatively, a plurality of patches are formed on the first surface of the substrate to form a two-dimensional optically machine readable symbol.

### BACKGROUND OF THE INVENTION

1. Field of the Invention

The present invention relates to optically identifiable radio frequency identification (RFID) tag devices.

2. Background Art

Radio frequency identification (RFID) tags are electronic devices that may be affixed to items whose presence is to be detected and/or monitored. The presence of an RFID tag, and therefore the presence of the item to which the tag is affixed, may be checked and monitored by devices known as “readers.” Readers typically transmit radio frequency signals to which the tags respond. Each tag can store a unique identification number.

Machine readable codes (e.g., barcodes) are another way of monitoring the presence of an item. Barcodes are affixed to items and can be scanned with a barcode scanner to determine an identity of the item. To bridge RFID and barcode technology, “Smart Labels” have been introduced that incorporate aspects of both RFID tags and barcodes. In Smart Labels, RFID and barcode portions are separate elements implemented together in a multilayered structure. Multilayered structures are typically more expensive to fabricate than single-layered structures and more difficult to source tag.

What is needed is a label assembly that more efficiently incorporates aspects of both RFID and barcode technology.

### BRIEF SUMMARY OF THE INVENTION

Methods and apparatuses for assembling and implementing machine readable radio frequency identification (RFID) tags are presented. In aspects, one or more antennas of an RFID tag are configured to be readable by a barcode scanner themselves.

In a first aspect of the present invention, an RFID tag includes a substrate, an antenna formed on the substrate that is configured to be machine readable, and an electrical circuit mounted on the substrate coupled to the antenna.

In an example aspect, the antenna includes a plurality of electrically conductive substantially rectangular bars formed on a first surface of the substrate. Bars of the plurality of electrically conductive substantially rectangular bars are positioned in parallel with each other and are configured to be optically machine readable. Bars of the plurality of electrically conductive substantially rectangular bars form at least one antenna.

The electrically conductive substantially rectangular bars may be coupled together in various ways. For example, in an aspect, an additional electrically conductive substantially rectangular bar is formed on the first surface of the substrate. The electrically conductive substantially rectangular bar is positioned perpendicular to the plurality of electrically conductive substantially rectangular bars and is coupled to at least one bar of the plurality of electrically conductive substantially rectangular bars. The electrical circuit is coupled to the electrically conductive substantially rectangular bar.

In further aspect, a second plurality of electrically conductive bars individually couples each bar of the first plurality of electrically conductive substantially rectangular bars to an adjacent electrically conductive substantially rectangular bar.

In another aspect, a method for assembling an RFID tag includes mounting an electrical circuit to a substrate to be electrically coupled to an antenna and forming the antenna on the substrate. The antenna is configured to be machine readable.

In a further aspect, forming the antenna includes forming a plurality of electrically conductive substantially rectangular bars on a surface of the substrate positioned in parallel.

In an aspect, communicating with an RFID tag includes scanning an antenna of the tag which is configured to be optically machine readable and transmitting and RF signal to be received by the antenna.

These and other advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an environment where RFID readers communicate with an exemplary population of RFID tags, according to an embodiment of the present invention.

FIG. 2 shows a block diagram of an example RFID reader.

FIG. 3A shows a block diagram of an example RFID tag.

FIG. 3B shows a top view of an example RFID tag.

FIGS. 4A and 4B show top and side views respectively of an RFID tag, according to an embodiment of the present invention.

FIG. 5 shows a top view of another RFID tag, according to an embodiment of the present invention.

FIG. 6 shows a top view of another RFID tag, according to an embodiment of the present invention.

FIGS. 7A and 7B show top and side views respectively of an RFID tag with two-dimensional barcode symbology, according to an embodiment of the present invention.

FIG. 8 shows a flowchart providing example steps for the assembly of an RFID tag, according to an embodiment of the present invention.

FIGS. 9-12 show example steps that may be performed in the flowchart of FIG. 8, according to an embodiment of the present invention.

FIG. 13 shows a flowchart providing an example step for communication between a device and a population of RFID tags.

FIG. 14 shows an example step that may be performed in the flowchart of FIG. 13, according to an embodiment of the present invention.

FIGS. 15A-15C illustrate systems for communicating with RFID tags, according to an embodiment of the present invention.

FIGS. 16-17 show example steps that may be performed in the flowchart of FIG. 13, according to embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

### Example RFID System Embodiment

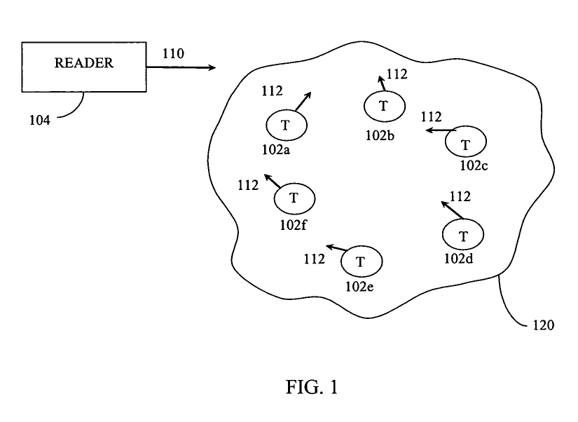

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network.

As shown in FIG. 1, reader 104 transmits an interrogation signal 110 having a carrier frequency to the population of tags 120. Readers 104 typically operates in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Reader 104 receives and obtains data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols.

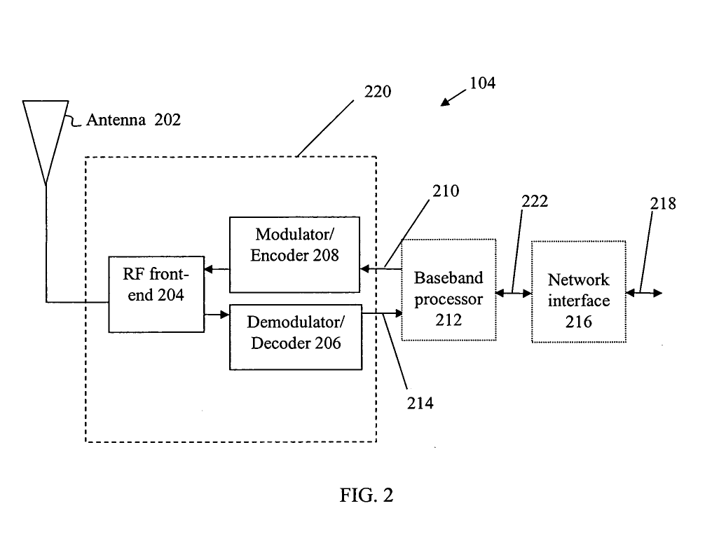

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

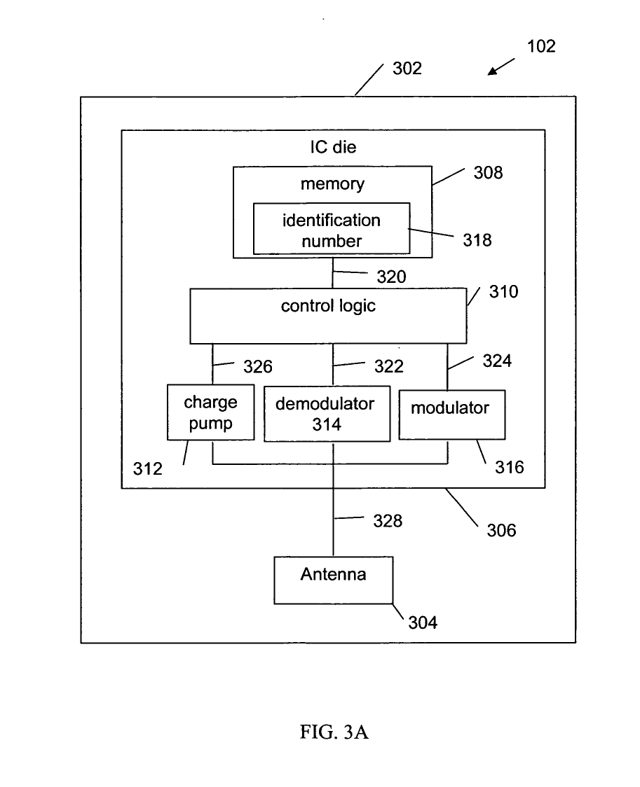

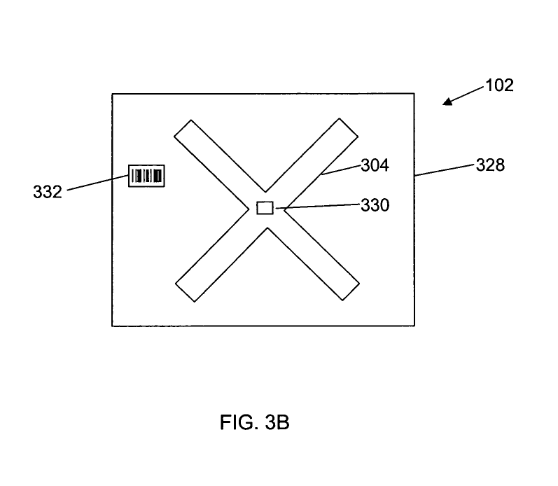

The present invention is applicable to any type of RFID tag. FIG. 3A shows a plan view of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example embodiment of FIG. 3, IC 306 includes a memory 308, a control logic 310, a charge pump 312, a demodulator 314, and a modulator 316. An input of charge pump 312, an input of demodulator 314, and an output of modulator 316 are coupled to antenna 304 by antenna signal 328. Note that in the present disclosure, the terms “lead” and “signal” may be used interchangeably to denote the connection between elements or the signal flowing on that connection.

Memory 308 is typically a non-volatile memory, but can alternatively be a volatile memory, such as a DRAM. Memory 308 stores data, including an identification number 318. Identification number 318 typically is a unique identifier (at least in a local environment) for tag 102. For instance, when tag 102 is interrogated by a reader (e.g., receives interrogation signal 110 shown in FIG. 1), tag 102 may respond with identification number 318 to identify itself. Identification number 318 may be used by a computer system to associate tag 102 with its particular associated object/item.

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Modulator 316 and demodulator 314 may be referred to collectively as a “transceiver” of tag 102.

Charge pump 312 is coupled to antenna 304 by antenna signal 328. Charge pump 312 receives a radio frequency communication signal (e.g., a carrier signal transmitted by reader 104) from antenna 304, and generates a direct current (DC) voltage level that is output on a tag power signal 326. Tag power signal 326 is used to power circuits of IC die 306, including control logic 320.

In an embodiment, charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification Tag Utilizing Charge Pumps for Voltage Supply Generation and Data Recovery,” which is incorporated by reference herein in its entirety. Alternative circuits for generating power in a tag are also applicable to embodiments of the present invention.

It will be recognized by persons skilled in the relevant art(s) that tag 102 may include any number of modulators, demodulators, charge pumps, and antennas. Tag 102 may additionally include further elements, including an impedance matching network and/or other circuitry. Embodiments of the present invention may be implemented in tag 102, and in other types of tags.

Embodiments described herein are applicable to all forms of tags, including tag “inlays” and “labels.” A “tag inlay” or “inlay” is defined as an assembled RFID device that generally includes an integrated circuit chip (and/or other electronic circuit) and antenna formed on a substrate, and is configured to respond to interrogations. A “tag label” or “label” is generally defined as an inlay that has been attached to a pressure sensitive adhesive (PSA) construction, or has been laminated, and cut and stacked for application. Another example form of a “tag” is a tag inlay that has been attached to another surface, or between surfaces, such as paper, cardboard, etc., for attachment to an object to be tracked, such as an article of clothing, etc.

FIG. 3B shows a plan view of an example physical layout of tag 102. In FIG. 3B, tag 102 includes a substrate 328, antenna 304, an electrical circuit 330 and a barcode 332. Electrical circuit 330 is formed/mounted on substrate 328. Electrical circuit 330 may be IC 306, another electrical circuit, and/or may include one or more elements of IC 306 shown in FIG. 3A. Electrical circuit 330 may store an identification code, such as identification number 318, that identifies tag 102. Electrical circuit 330 may be commercially available as a single integrated circuit or may have separate components that are assembled with tag 102.

Barcode 332 is formed on substrate 328. Barcode 332 includes a plurality of substantially rectangular bars that are configured to be optically machine readable, such as by a barcode scanner device. The plurality of bars symbolizes an identification code that can be determined when a barcode scanner scans barcode 332.

As shown in FIG. 3, barcode 332 and other elements of tag 102, including antenna 304, are essentially isolated. This isolation leads to inefficient use of space in tag 102 and makes source tagging more difficult. Embodiments of the present invention overcome these limitations of conventional barcoded RFID tags.

Example embodiments of the present invention are described in further detail below. Such embodiments may be implemented in the environments and readers described above, and/or in alternative environments and alternative RFID devices.

### Example RFID Tag Embodiments

Methods, systems, and apparatuses for machine readable RFID tags are presented. In an embodiment, an RFID tag includes a substrate and an antenna. The antenna is configured to be an optically machine readable symbol.

The example embodiments described herein are provided for illustrative purposes, and are not limiting. The examples described herein may be adapted to any type of RFID tag, including semiconductor based tags and surface acoustic wave (SAW) tags. Further structural and operational embodiments, including modifications/alterations, will become apparent to persons skilled in the relevant art(s) from the teachings herein.

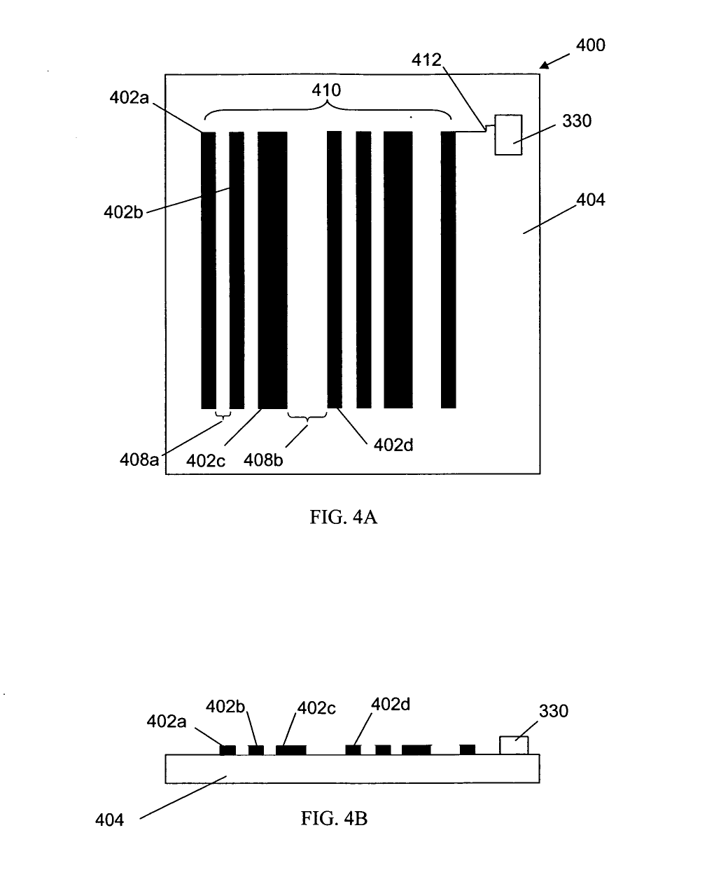

FIGS. 4A and 4B show an example RFID tag 400, according to an embodiment of the present invention. RFID tag 400 includes a plurality of bars 410, a substrate 404, and electrical circuit 330. Plurality of bars 410 includes multiple bars 402. In an embodiment, each bar 402 of plurality of bars 410 is substantially rectangular in shape. Bars 402 of the plurality of bars 402 are made of an electrically conductive material such as copper, aluminum, and/or metallic paint. As shown in FIG. 4A, bars of 402 the plurality of bars 410 are positioned in parallel with each other.

Plurality of bars 402 is configured to be optically machine readable (e.g., to be readable as a barcode or other machine readable symbol type). For instance, plurality of bars 402 may be configured to symbolize at least one identification code. The identification code is determined when plurality of bars 402 is scanned by a scanning device. Plurality of bars 402 may conform to standard symbologies such as EAN-13, UPC-A, and/or any other symbology, as would be understood by persons skilled in the relevant art(s). Furthermore, electrical circuit 330 may store the identification code, which may be obtained by reading tag 400 with an RFID reader.

Bars of plurality of bars 402 may be of different sizes. For example, as shown in FIG. 4A, bar 402c is wider than bar 402a. Furthermore, bars of the plurality of bars 402 may have different spacing. For example, as shown in FIG. 4A, a distance 408a between bar 402a and bar 402b is smaller than a distance 408b between bar 402c and bar 402d. Such variation of widths and spacing may be made as needed for a particular barcode function, as would be known to persons skilled in the relevant art(s).

Bars of plurality of bars 402 also form at least one antenna. The antenna formed by bars of the plurality of bars 402 performs functions similar to antenna 304 shown in FIGS. 3A and 3B. In an embodiment, separately, bars 402 of the plurality of bars 410 may be viewed as microstrip transmission lines. One or more of these microstrip transmission lines are positioned on a first (top) surface of substrate 404 such that there is sufficient electromagnetic coupling between the transmission lines to form an antenna. Plurality of bars 410, and thus the antenna, is coupled to electrical circuit 330 via an electrical connection 412. Electrical connection 412 may be one or more electrically conductive traces, or other type of electrical connection, formed on or in substrate 404.

Substrate 404 may be one of a variety of different types of substrates, such as paper (e.g., a label of an item), a flex-tape substrate, a plastic, including a polymer such as polyester, a resin such as FR-4, etc., as would be understood by someone skilled in the relevant art(s).

In an embodiment, tag 400 is attached to an item in any form, including as an inlay or label. In another embodiment, substrate 404 is material of a package. Plurality of bars 410 are formed on the package material, and electrical circuit 330 (e.g., in the form of an IC chip) is attached directly to plurality of bars 410 on the package material. In such a direct attachment configuration, an electrical connection between bars 410 and electrical circuit 330 may be formed by staking and/or by other technique, as would be known to persons skilled in the relevant art(s). In such an embodiment, electrical connection 412 may not be necessary.

In an embodiment, plurality of bars 410 is configured to identify the item. The item may be a package or a consumer product such as a food container, appliance, etc. Thus, when attached to an item, tag 400 allows the presence of the item to monitored using both optical machine readable technology and by RFID technology.

A portion of tag 400 may be sealed in a sealant that prevents damage from environmental elements. The sealant may be configured to not obscure plurality of bars 410, so that they may be scanned by a scanner. For example, the sealant may be transparent.

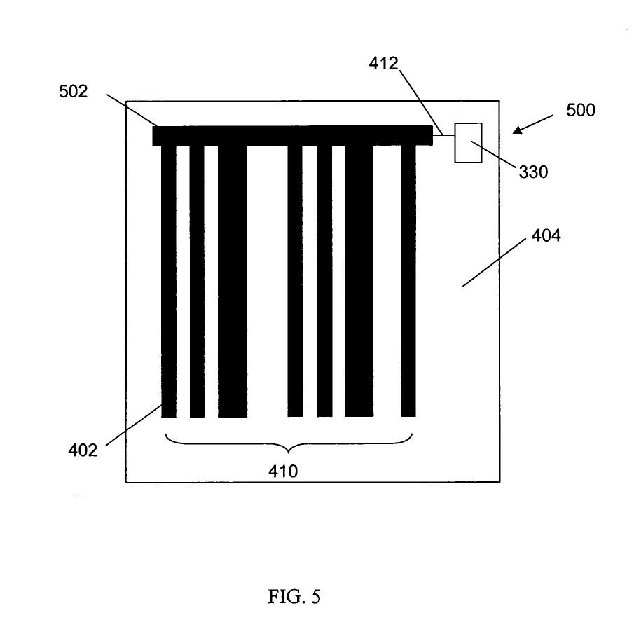

FIG. 5 shows another example RFID tag 500, according to an embodiment of the present invention. Tag 500 is substantially similar to tag 400 shown in FIGS. 4A and 4B with some differences described as follows. Tag 500 additionally includes bar 502 coupled to plurality of bars 410. In this manner, plurality of bars 410 are electrically coupled together by bar 502. Bar 502 is made of an electrically conductive material such as copper, aluminum, and/or metallic paint. As shown in FIG. 5, electrical circuit 330 is coupled to plurality of bars 410 through bar 502. FIG. 5 also shows bar 502 coupling to each bar 402 of plurality of bars 410. In alternate embodiments, however, bar 502 may be coupled to a subset of plurality of bars 410.

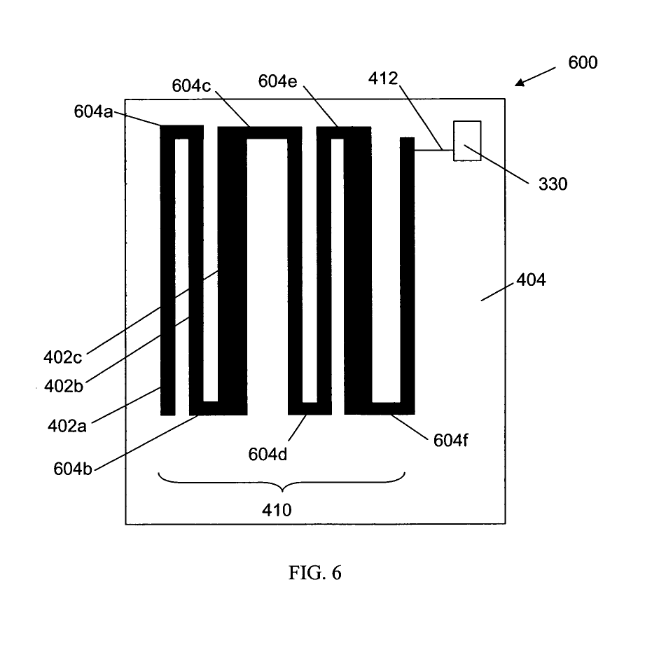

FIG. 6 shows another RFID tag 600, according to an embodiment of the present invention. Tag 600 is substantially similar to tag 400 shown in FIGS. 4A and 4B with some differences described as follows. Tag 600 additionally includes bars 604a-604f that each couple a pair of adjacent bars of plurality of bars 410. Bars 604a-604f are positioned at alternating opposing ends of adjacent pairs of bars 402. For example, bar 604a couples bar 402a to bar 402b at a first end of plurality of bars 410, and bar 604b couples bar 402b to bar 402c at a second end of plurality of bars 410. Thus, bars 402 of plurality of bars 410 are coupled to adjacent bars 402 by bars 604 in an oscillating fashion, forming a repeating “S” shape. In alternate embodiments, however, bars of the plurality of bars 410 may be individually coupled in other arrangements as would be understood by someone skilled in the relevant art(s). For example, adjacent bars 604 do not necessarily have to be positioned at opposing ends of plurality of bars 410, and instead, adjacent bars 604 may be positioned at a same end of plurality of bars 410.

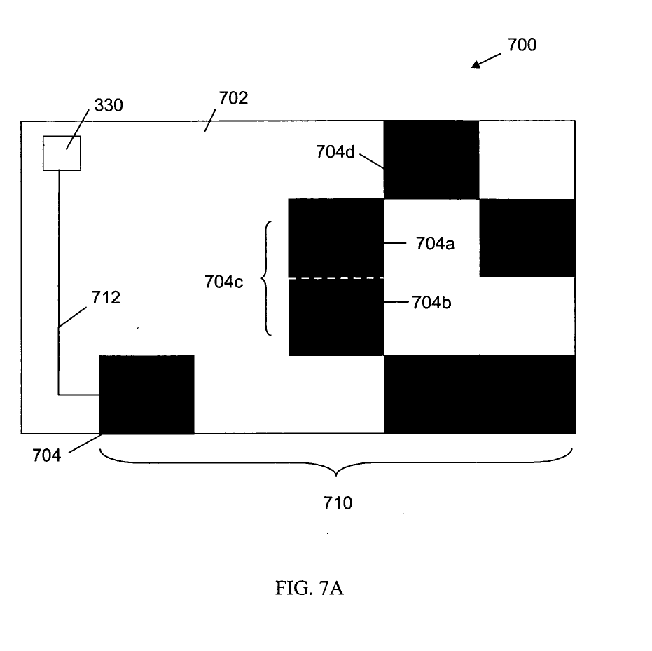

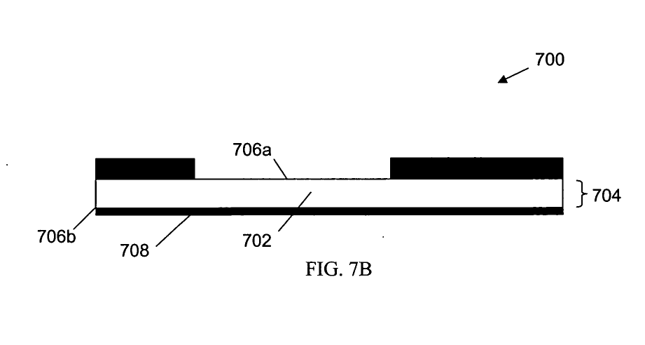

FIGS. 7A and 7B show top and side views, respectively, of another example RFID tag 700, according to an embodiment of the present invention. RFID tag 700 includes a substrate 702, a plurality of patches 710, and electrical circuit 330. An electrical connection 712 couples electrical circuit 330 to plurality of patches 710. Plurality of patches 710 includes multiple patches 704 that are arranged in a two dimensional array. As shown in FIG. 7A, each patch 704 is substantially rectangular in shape. Moreover, two or more patches may be placed adjacent to each other to form a larger patch. For example, in FIG. 7A, patches 704a and 704b are placed adjacent to each other to form patch 704c. Each patch 704 of plurality of patches 710 are made of an electrically conductive material such as copper, aluminum, and/or metallic paint.

Plurality of patches 710 is configured to be optically machine readable. In contrast to the RFID tags shown in FIGS. 4A, 4B, 5 and 6, tag 700 is configured to have a two-dimensional symbology, rather than a one-dimensional symbology. The two dimensional symbology formed by patches 704 may symbolize an identification number for tag 700.

Plurality of patches 710 is also configured to form at least one antenna. The antenna performs substantially similar operations as antenna 304 shown in FIGS. 3A and 3B. For example, in an embodiment, plurality of patches 710 is configured to operate as a patch antenna as would be known to persons skilled in the relevant art(s). Alternatively, patches 704 of plurality of patches 710 may be coupled together at adjacent corners, such as patches 704a and 704d in FIG. 7A, and/or in a side by side fashion, such as patches 704a and 704b, to form a chain of patches 704 of any length that may operate as a dipole antenna.

In an embodiment, substrate 704 may be substantially similar to substrate 404 in FIGS. 4A, 4B, 5 and 6, or may some differences described as follows. Substrate 704 has a first (e.g., top) surface 706a and a second (e.g., bottom) surface 706b. Top surface 706a has patches 710 formed thereon. In an embodiment, second surface 706b is at least partially covered in an electrically conductive layer 708, as shown in FIG. 7B. Plurality of patches 710 may be coupled to each other through substrate 704 to layer 708, such as by staking and/or by vias through substrate 740. Thus, conductive layer 708 serves as a connection plane for plurality of patches 710, and may serve as a ground plane for the antenna(s) formed by patches 704 of plurality of patches 710 (if needed).

As shown in FIG. 7A, electrical circuit 330 is on top surface 706a. In alternate embodiments, however, electrical circuit may be placed on another surface of substrate 704, may be placed within a cavity formed in a surface of substrate 704, or may be located off substrate 704.

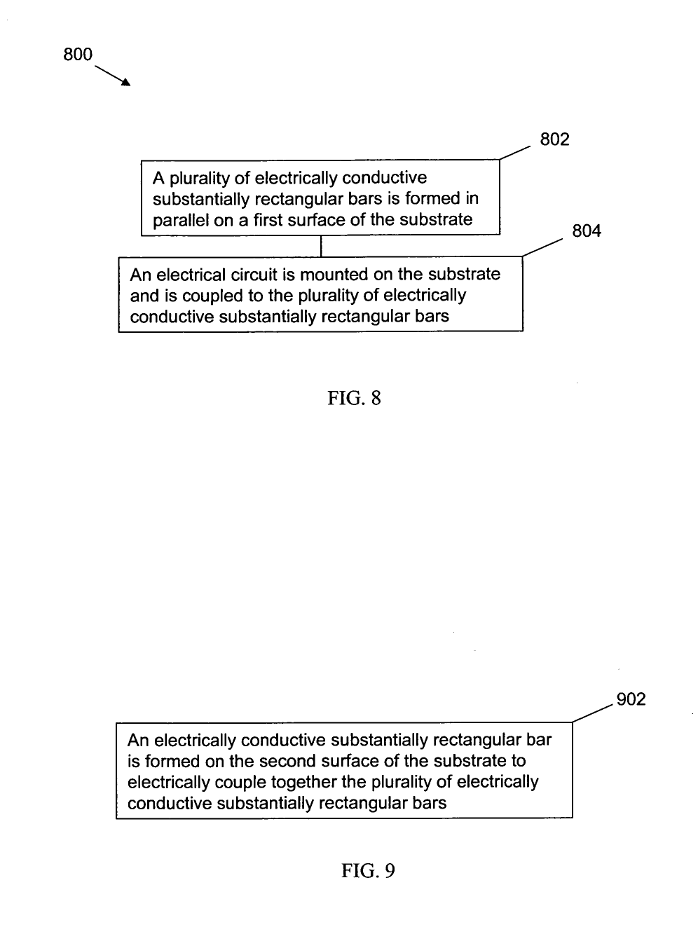

FIG. 8 shows flowchart 800 providing example steps for assembly of an RFID tag, according to an embodiment of the present invention. Other structural and operational embodiments will be apparent to persons skilled in the relevant art(s) based on the following discussion. The steps of FIG. 8 are described in detail below.

Flowchart 800 begins with step 802. In step 802, a plurality of electrically conductive substantially rectangular bars is formed in parallel on a first surface of the substrate. For example, in FIG. 4A, plurality of bars 410 is formed on the top surface of surface of substrate 404. Bars of plurality of bars 410 are positioned in parallel to each other and configured to be optically machine readable and to operate as a tag antenna.

In step 804, an electrical circuit is mounted on a surface of a substrate and is coupled to the plurality of electrically conductive substantially rectangular bars. For example, in FIG. 4A, electrical circuit 330 is mounted to the first surface of substrate 404. Alternatively, electrical circuit 330 may be mounted on a second (bottom) surface or any other surface of substrate 404 as would be understood by someone skilled in the relevant art(s).

FIGS. 9-12 show example additional steps for flowchart 800, according to embodiments of the present invention.

FIG. 9 shows step 902. In step 902, an electrically conductive substantially rectangular bar is formed on the second surface of the substrate to electrically couple together the plurality of electrically conductive substantially rectangular bars. For example, in FIG. 5, bar 502 is formed perpendicular to plurality of bars 410 on the first surface of substrate 404. Electrical circuit 330 is coupled to bar 502. Bar 502 is coupled to each bar of plurality of bars 410. In alternate embodiments, bar 502 may be coupled a subset of plurality of bars 410 instead of each bar of plurality of bars 410.

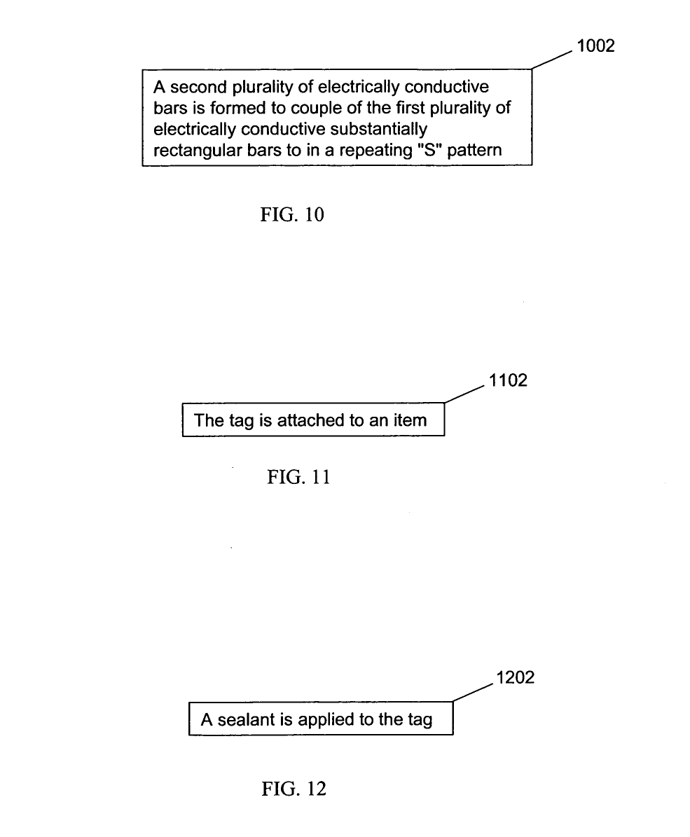

FIG. 10 shows step 1002. In step 1002, a second plurality of electrically conductive bars is formed to couple each of the first plurality of electrically conductive substantially rectangular bars to in a repeating “S” pattern. For example, in FIG. 6, bars 604a-604f couple bars of the plurality of bars 410 in a repeating “S” pattern. In alternate embodiments, however, bars 604a-604f may individually couple plurality of bars 410 in another pattern, as would be understood by someone skilled in the relevant art(s).

FIG. 11 shows step 1102. In step 1102, the tag is attached to an item. In such an embodiment where the item is a consumer product, the plurality of bars symbolizes an identification code. The identification code may be determined by an optical scanner (e.g. a barcode scanner) and be used to identify the product. Thus the product's presence may be tracked using both RFID technology through the antenna formed by the plurality of bars and barcode technology.

Note that alternatively to step 1102, the substrate mentioned in steps 802 and 804 is a packaging material. Thus, in such an embodiment, the packaging material may be applied to the item after steps 802 and 804. Alternatively, steps 802 and 804 may be performed on the packaging material, where the packaging material has been previously applied to the item.

FIG. 12 shows step 1202. In step 1202, a sealant is applied to the tag. The sealant provides protection from environmental elements that may damage the tag.

Although the aforementioned steps discuss the assembly of a single RFID tag, the example steps may also be applied to a process in which multiple tags are assembled simultaneously. In an embodiment, multiple tags are assembled simultaneously using Parallel Integrated Chip Assembly (PICA) technology, sold by Symbol Technologies, Inc., of Holtsville, N.Y.

### Example RFID Tag Implementation Embodiments

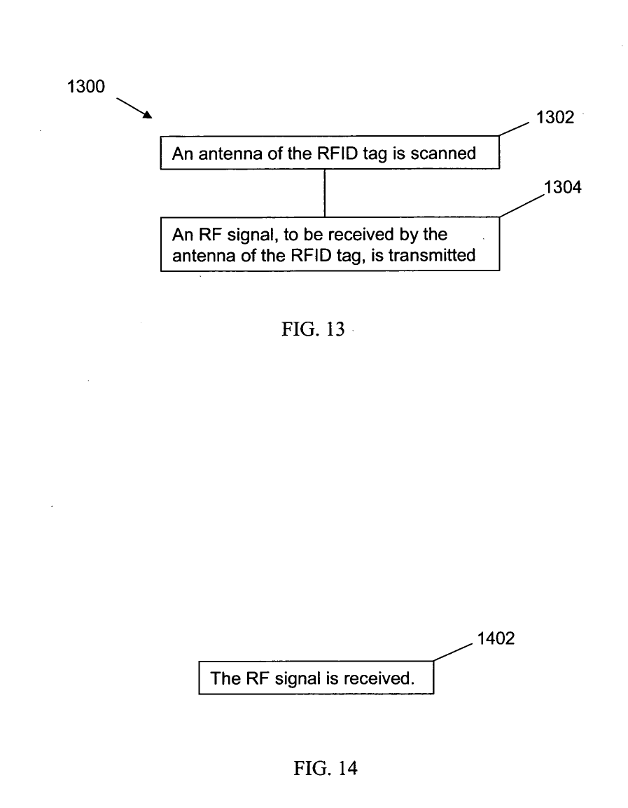

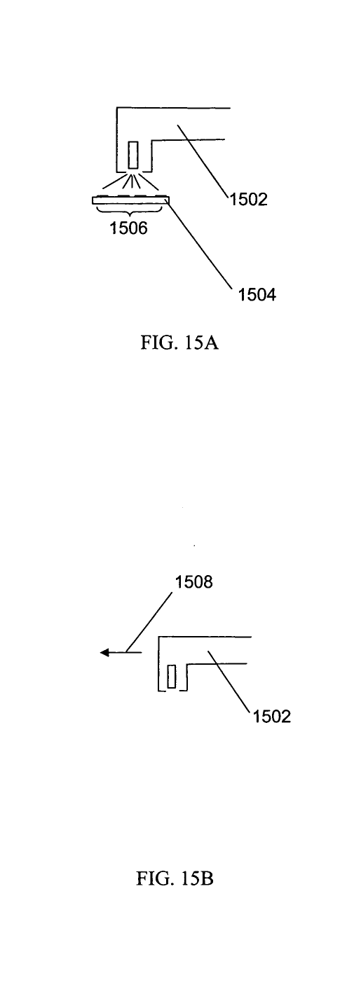

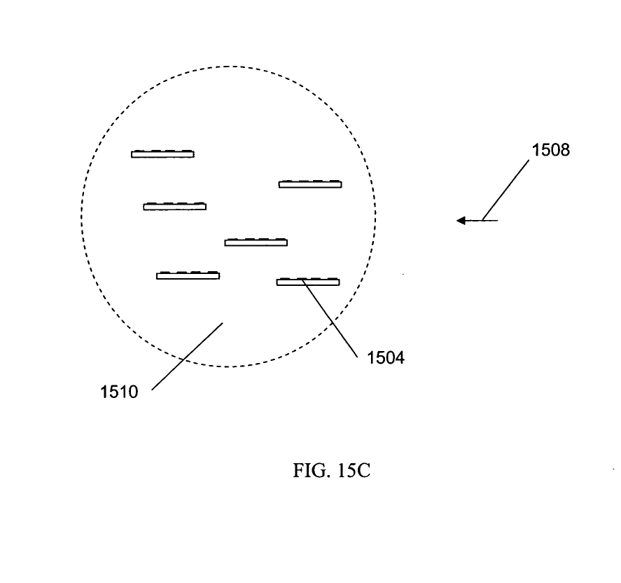

FIG. 13 shows flowchart 1300 providing example steps for communicating with an RFID tag, according to an embodiment of the present invention. Other structural and operational embodiments will be apparent to persons skilled in the relevant art(s) based on the following discussion. The steps of FIG. 13 are described in detail below. FIGS. 15A-15C show systems for communicating with RFID tags and are referred to during the description of flowchart 130 provided below, for illustrative purposes.

Flowchart 1300 begins with step 1302. In step 1302, an antenna of the RFID tag is scanned. For example, in FIG. 15A, a scanner 1502 scans an antenna 1506 of tag 1504. Although FIG. 15A shows antenna 1506 as being a plurality of bars, antenna 1506 may have any arrangement that is optically machine readable, such as a plurality of patches as shown in FIGS. 7A and 7B. Moreover, scanner 1502 may be any type of scanner such as a 2- or 3-dimensional optically readable symbol scanner (e.g., a barcode scanner), as desired. In an embodiment, An identification number of the tag may also be determined from data recovered from a scan of antenna 1506.

In step 1304, an RF signal, to be received by the antenna of the RFID tag, is transmitted. For example, in FIG. 15B, scanner 1502 transmits an RF signal 1508. In an embodiment, the transmitted RF signal includes the identification number determined during the scan of antenna 1506.

FIGS. 14, 16, and 17 show an example additional steps for flowchart 1300, according to embodiments of the present invention.

FIG. 14 shows step 1402. In step 1402 the RF signal is received (by one or more tags). In an embodiment, one or more tags in a communication range of the transmitted signal receive the RF signal. For example, in FIG. 15C, each tag of a plurality of tags 1510, including tag 1504, are within a communication range of RF signal 1508 and receive RF signal 1508. In alternate embodiments, one or more tags of plurality of tags 1510 do not receive RF signal 1508.

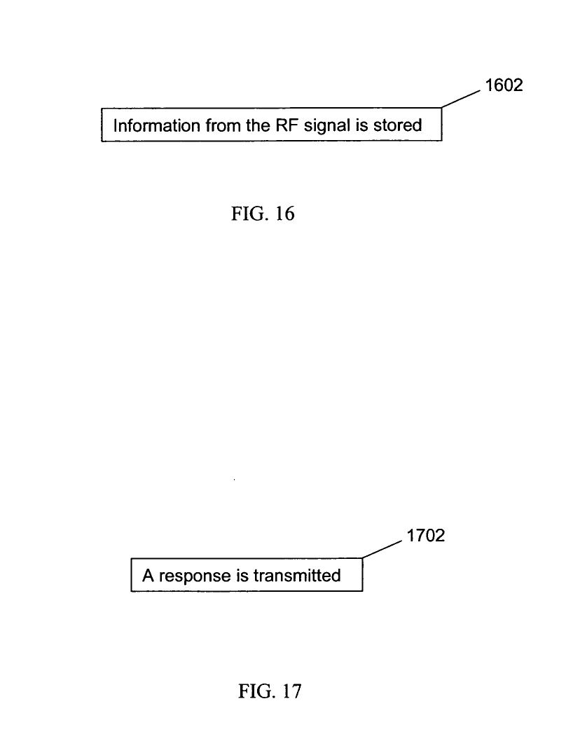

FIG. 16 shows step 1602. In step 1602, information from the RF signal is stored. The RF signal may contain the identification code. In an embodiment, a tag within the communication range of the transmitted signal stores information from the RF signal, and/or responds to the RF signal, only if the identification code received in the scan (and used in the transmitted RF signal) matches an identification code of the tag. For example, in a further embodiment, the information may be a command to deactivate the tag. If the transmitted RF signal includes the identification code of a tag, the tag deactivates itself. In alternative embodiments, other types of commands to tags may be handled in this manner.

FIG. 17 shows step 1702. In step 1702, a response to the RF signal is transmitted. In an embodiment, the RF signal is an interrogation signal. Thus, a tag transmits a response signal that confirms that the tag received the RF signal.

### Example Computer System Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system using a removable storage drive, hard drive, or communications interface. The control logic (software), when executed by a processor, causes the processor to perform the functions of the invention as described herein.

According to an example embodiment, a device may execute computer-readable instructions to read RF tags, to scan optically readable tag antennas, to write identification information to tags, and/or to perform other functions, as further described elsewhere herein.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A radio frequency identification (RFID) tag, comprising:
a substrate having opposing first and second surfaces;
an antenna formed on the substrate, wherein the antenna is configured to be an optically machine readable symbol; and
an electrical circuit mounted on the substrate and coupled to the antenna.

2. The tag of claim 1, wherein the antenna comprises:
a plurality of electrically conductive substantially rectangular bars formed on the first surface of the substrate, wherein bars of the plurality of electrically conductive substantially rectangular bars are positioned in parallel with each other.

3. The RFID tag of claim 2, further comprising:
an electrically conductive substantially rectangular bar, wherein the electrically conductive substantially rectangular bar is positioned perpendicular to bars of the plurality of electrically conductive substantially rectangular bars, wherein a first surface of the electrically conductive substantially rectangular bar is electrically coupled to at least one bar of the plurality of electrically conductive substantially rectangular bars, wherein the electrical circuit is electrically coupled to the electrically conductive substantially rectangular bar.

4. The RFID tag of claim 2, further comprising:
a second plurality of electrically conductive bars that couple a surface each bar of the first plurality of electrically conductive substantially rectangular bars to a surface of an adjacent electrically conductive substantially rectangular bar of the plurality of electrically conductive substantially rectangular bars.

5. The RFID tag of claim 2, wherein each bar of the plurality of electrically conductive substantially rectangular bars comprises metallic paint, copper, or silver.

6. The RFID tag of claim 2, further comprising a sealant that seals at least a portion of the RFID tag.

7. The RFID tag of claim 2, wherein the plurality of electrically conductive substantially rectangular bars is configured to conform to an EAN-13 barcode symbology or an UPC-A barcode symbology.

8. The RFID tag of claim 1, wherein the antenna comprises:
a plurality of electrically conductive substantially rectangular patches formed on a surface of the substrate, wherein the plurality of patches is configured to be optically machine readable.

9. The RFID tag of claim 8, further comprising an electrically conductive material that covers at least a portion of the second surface of the substrate.

10. The RFID tag of claim 8, wherein each patch of the plurality of patches comprises copper, mettalic paint, or silver.

11. A method of assembling an RFID tag:
mounting an electrical circuit onto a substrate to be coupled to an antenna; and
forming the antenna on the substrate.

12. The method of claim 11, wherein forming the antenna comprises:
forming a plurality of electrically conductive substantially rectangular bars on a surface of the substrate, wherein bars of the plurality of electrically conductive substantially rectangular bars are positioned in parallel, wherein the plurality of electrically conductive substantially rectangular bars is configured to be optically machine readable.

13. The method of claim 12, further comprising:
forming a electrically conductive substantially rectangular bar on the second surface of the substrate, wherein the electrically conductive substantially rectangular bar is positioned perpendicular to the plurality of electrically conductive substantially rectangular bars, wherein a first surface of the electrically conductive substantially rectangular bar is electrically coupled to at least one bar of the plurality of electrically conductive substantially rectangular bars, wherein the electrical circuit is electrically coupled to the electrically conductive substantially rectangular bar.

14. The method of claim 12, further comprising:
forming a plurality of electrically conductive bars that couple each bar of the plurality of electrically conductive substantially rectangular bars to an adjacent electrically conductive substantially rectangular bar of the plurality of electrically conductive substantially rectangular bars.

15. The method of claim 11, further comprising:
attaching the RFID tag to an item.

16. The method of 11, further comprising:
sealing the RFID tag in a sealant.

17. The method of 12, wherein the plurality of electrically conductive substantially rectangular bars is configured to conform to an EAN-13 barcode symbology or an UPC-A barcode symbology.

18. A method for communicating with an RFID tag comprising:
scanning an antenna of the RFID tag, wherein the antenna of the RFID tag is configured to be optically machine readable; and
transmitting an RF signal to a the RFID tag to be received by the antenna of the RFID tag.

19. The method of claim 18, wherein the scanning step further comprises:
determining an identification code of the RFID tag.

20. The method of claim 18, further comprising, receiving the RF signal.

21. The method of claim 20, further comprising:
storing information in the RF signal, wherein the RF signal contains the identification code, wherein any tag within a communication range of the RF signal stores information from the RF signal only if the identification code matches an identification code of the tag within the communication range of the RF signal.

22. The method of claim 21, wherein the information is a command to deactivate, further comprising, deactivating the tag if the information is stored.

23. The method of claim 20, wherein a response to the RF signal is sent.

24. The method of claim 18, wherein the RF signal is an interrogation signal.

25. A system for communicating with an RFID tag, comprising:
means for scanning an antenna of the RFID tag, wherein the antenna of the RFID tag is configured to be optically machine readable; and
means for transmitting an RF signal to a the RFID tag to be received by the antenna of the RFID tag.

26. The system of claim 25, further comprising:
means for storing information in the RF signal, wherein the RF signal contains an identification code, wherein any tag within a communication range of the RF signal stores information from the RF signal only if the identification code matches an identification code of the tag within the communication range of the RF signal.
